(19) United States
(12) Patent Application Publication
(10) Pub. No.: US 2002/0165791 A1
(43) Pub. Date: Nov. 7, 2002

(54) Repair order receiving and sending system using customer's unnecessary assets and method thereof

(75) Inventors: Satoko Segawa, Kawasaki (JP); Masashi Uyama, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/956,934

(22) Filed: Sep. 21, 2001

(30) Foreign Application Priority Data
May 1, 2001 (JP) 2001-134481

(51) Int. Cl. G06F 17/60

(52) U.S. Cl. 705/26

(57) ABSTRACT

A repair component is specified based on repair request information including at least failure information of a product to be repaired and a desired repair fee. A component information database and an owner information database are searched based on the specified repair product, whereby component providing candidates owning a product including the repair component are selected. A purchase reference price is input based the desired repair fee to notify the component providing candidates of the purchase reference price. An evaluation value is calculated which is an index for evaluating a residual value of the repair component on the component providing candidate basis from selling component information containing a desired selling price, and a component providing candidate that provides a repair component having the highest evaluation value is selected as a component provider. A repair fee is input, and the repair requester is notified of repair information containing the repair fee.

### BACKGROUND OF THE INVENTION

1. Field of the Invention

The present invention relates to a repair order receiving and sending system using customer's unnecessary assets for determining a repair fee incurred when a repair order is sent for a broken-down product, and a method thereof.

2. Description of the Related Art

With the recent tendency of a shortened cycle of a product, a model change cycle of various kinds of equipment are rapidly becoming short. Because of this, the number of components for repair/exchange to be stored by a manufacturer so as to be used in the event of failure is increasing in series.

Under such a circumstance, an increase in a management cost of components for repair/exchange cannot be avoided on the side of a manufacturer, which also enhances the feeling that a repair/exchange fee is comparatively high. Due to an increase in the price of components, a repair fee is also becoming very high. Therefore, even in the case where a user wants to continue to use a product by repairing it or the like, the user has the feeling that buying a new product is less expensive, considering a repair fee or the like. Consequently, irrespective of whether the product can be used if repaired, the user is urged to buy a new product.

FIGS. 1A and 1B show conventional repair processing of a product. FIG. 1A shows a flow of a product in conventional repair, and FIG. 1B shows a cost incurred in the conventional repair and a flow thereof.

As shown in FIG. 1A, a repair requester 1 sends a repair order to a support center or the like of a manufacturer 2, and sends a broken-down product to the manufacturer 2. The manufacturer 2 that has received the repair order exchanges a component of the product with a corresponding stock component, and returns it to the repair requester 1 as a repaired product. In this case, a stock component stored in the manufacturer 2 is used as a component for repair/exchange, and the price of such a stock component is mostly set comparatively high due to an increase in a management cost or the like.

FIG. 1B shows a cost incurred in such a repair method and a flow thereof. The repair fee can be roughly classified into a labor cost, a repair component price, and a management fee of a repair component. Recently, the ratio of a repair component price and a management fee of a repair component is increasing. Therefore, in order for a repair requester to minimize a repair fee, it is important to reduce a cost for acquiring components, such as a repair component price and a management fee of a repair component.

It is considered that a product purchased by a general consumer on the market is retrieved, and a usable component contained in a second-hand product is used as a repair component. According to such a method, a cost for acquiring a repair component can be rendered lower than that for acquiring a new component. On the other hand, a management fee of a repair component is not incurred on the side of a manufacturer. Therefore, it is considered that repairs can be made at a lower cost, compared with the case where repairs are made with a new component stored by a manufacturer.

For example, FIG. 2A shows a flow of a product under repair based on the use of a second-hand component contained in a recovered second-hand product. FIG. 2B shows a cost incurred in repair based on the use of a second-hand component contained in a recovered second-hand product, and a flow thereof.

As shown in FIG. 2A, the repair requester 1 sends a repair order to a repairer 3 for a broken-down product, and sends the broken-down product to the repairer 3. The repairer 3 that has received a repair order takes a corresponding repair component (second-hand component) from the same kind of second-hand product previously recovered for recycling from a general consumer (component provider) 4, exchanges a component of the broken-down product with the second-hand component, and returns it to the repair requester 1 as a repaired product. In this case, instead of a stock component stored by the manufacturer 2, a second-hand component taken from a recovered second-hand product is used as a component for repair/exchange. Therefore, unlike a stock component, a management cost is not generally incurred. Furthermore, since a recovery cost is generally lower than a cost for acquiring a new component, a repair fee can be set relatively low.

FIG. 2B shows a cost incurred in such a repair method and a flow thereof. A repair fee is roughly classified into a labor cost and a repair component price. A repair component price can be made lower. This is because a cost for purchasing a second-hand product from the general consumer (component provider) 4 is generally lower than that for using a stock component of a manufacturer.

However, according to the method for using a usable component contained in a second-hand product acquired for recycling as a repair component, there remain the following problems.

If components to be acquired are selected based on the price thereof, second-hand components whose warranty period almost expires may be selected. In this case, continuous use substantially by making repairs, which is expected by a repair requester, may not be achieved.

The original object of a repair requester is to acquire a component that is as less expensive as possible and has a long warranty period. A component that is used only for a short period of time due to a short warranty period cannot be continuously used by making repairs, even if the price thereof is low. It is also considered to newly provide a warranty period in a recovered second-hand product. However, in this case, there is no warranty of a manufacturer, so that warranty for exact operation cannot be obtained. Therefore, there is no difference.

If a component with a long warranty period is acquired with the same price as that of a new component, there is no point in acquiring a second-hand component. More specifically, the reason for acquiring a second-hand product is to minimize a cost for acquiring a component for repair/exchange, since the price of a component for repair/exchange stored by a manufacturer is increased. If a second-hand component has the same price as that of a stock component of a manufacturer, it is not necessary to acquire a second-hand component that is most likely to be defective.

### SUMMARY OF THE INVENTION

Therefore, with the foregoing in mind, it is an object of the present invention to provide a repair order receiving and sending system using customer's unnecessary assets, capable of determining an entity for acquiring a repair component by objectively evaluating a use value for a repair requester acquiring a repair component, and a method thereof.

In order to achieve the above-mentioned object, a repair order receiving and sending system using customer's unnecessary assets of the present invention is operated on a repairer server in which the repairer server, a repair requester terminal used by a repair requester, and a component providing candidate terminal used by a component providing candidate are connected to each other on a network, the repairer server including: a component information database storing components and products using the components so that they correspond to each other; an owner information database storing customers owning the products as potential component providers; a repair request information receiving part for receiving repair request information at least containing failure information on a product to be repaired and a desired repair fee, transmitted from the repair requester terminal; a repair component specifying part for specifying a repair component based on the failure information; a component providing candidate selecting part for searching the component information database and the owner information database based on the specified repair component, thereby selecting one or a plurality of customers owning one or a plurality of products including the repair component as the component providing candidate; a reference purchase price input part for repairer's inputting a reference purchase price based on the desired repair fee; a purchase component information notifying part for notifying the selected component providing candidate of purchase component information at least containing information for specifying a component desired to be purchased and the reference purchase price of the component desired to be purchased; a selling component information receiving part for receiving selling component information containing a desired selling price of the repair component from the component providing candidate; a component provider selecting part for selecting a component provider from the component providing candidate based on the selling component information; a repair fee input part for inputting a repair fee presented to the repair requester; and a repair information sending part for sending repair information at least containing the repair fee to the repair requester terminal.

Because of the above-mentioned configuration, a repair requester acquiring a repair component can select only an owner capable of providing a second-hand component as a component providing candidate among owners of products including a component desired to be repaired, and optimum repair component can be efficiently searched for.

Furthermore, in the repair order receiving and sending system using customer's unnecessary assets of the present invention, it is preferable that the selling component information receiving part receives the selling component information together with information for determining a residual value of the repair component, the repairer server further includes an evaluation value calculating part for calculating an evaluation value, which is an index for evaluating a residual value of the repair component on the component providing candidate basis, based on the desired selling price and the information for determining a residual value of the repair component, and the component provider selecting part selects the component providing candidate that provides the repair component with the highest evaluation value as a component provider. According to this configuration, a repair requester acquiring a repair component can determine a destination for acquiring a repair component based on an evaluation value of a repair component, which is an index for objectively evaluating a residual value of the repair component. Therefore, repair can be made more effectively and exactly at a lower cost compared with the case of requesting repair of a manufacturer.

Furthermore, in a repair order receiving and sending system using customer's unnecessary assets of the present invention, it is preferable that the repairer server further includes an order sending information receiving part for receiving a notice of order sending information from the repair requester terminal, and a selling request notifying part for notifying the component provider that the product or the repair component is purchased at the desired selling price, based on the order sending information. This is because a repair requester finally determines whether or not to accept a repair fee.

Next, in order to achieve the above-mentioned object, a repair order receiving and sending system using customer's unnecessary assets of the present invention is operated on a provider server provided by a provider, in which the provider server is connected to a repairer terminal used by a repairer and a repair requester terminal used by a repair requester on a network, the provider server including: a repairer database storing the repairers and products that can be repaired by the repairers so that they correspond to each other; a repair request information receiving part for receiving repair request information at least containing information for specifying a product to be repaired and a desired repair fee, transmitted from the repair requester terminal; a candidate repairer extracting part for searching the repairer database based on the information for specifying the product to be repaired, and extracting one or a plurality of candidate repairers that can repair the product; a repair request information notifying part for notifying the repairer terminal used by the candidate repairer of repair request information from the repair requester; a repairer selecting part for selecting the candidate repairer with the lowest repair fee as a repairer, among the entire input repair information; and an order notifying part for notifying the repair requester terminal of the repair information and order receiving, and an order sending notifying part for notifying the repairer terminal of order sending.

Because of the above-mentioned configuration, a repair requester acquiring a repair component can select an optimum repairer from a plurality of repairers without searching for a repairer on its own.

Furthermore, it is preferable that a repair order receiving and sending system using customer's unnecessary assets of the present invention includes a repair information notifying part for notifying the repair requester terminal of all the repair information sent from the repairer, wherein the repairer selecting part selects a repairer selected by the repair requester based on the repair information for sending an order, and sent from the repair requester terminal, and the order notifying part notifies the repairer terminal used by the selected repairer of the order. This is because it is preferable that a repair requester finally selects a repairer.

Furthermore, the present invention is characterized by a recording medium storing a computer-executable program for executing functions of the above-mentioned order receiving and sending system using customer's unnecessary assets as processing operations of a computer. More specifically, the present invention relates to a method for receiving and sending a repair order using customer's unnecessary assets in a network environment in which a repairer server, a repair requester terminal used by a repair requester, and a component providing candidate terminal used by a component providing candidate are connected to each other on a network, the repairer server including: receiving repair request information at least containing failure information on a product to be repaired and a desired repair fee, transmitted from the repair requester terminal; specifying a repair component based on the failure information; searching the component information database storing components and products using the components so that they correspond to each other and the owner information database storing customers owning the products as potential component providers, based on the specified repair component, thereby selecting one or a plurality of customers owning one or a plurality of products including the repair component as the component providing candidate; inputting a reference purchase price based on the desired repair fee; notifying the selected component providing candidate of purchase component information at least containing information for specifying a component desired to be purchased and the reference purchase price of the component desired to be purchased; receiving selling component information containing a desired selling price of the repair component from the component providing candidate; selecting a component provider from the component providing candidate based on the selling component information; inputting a repair fee presented to the repair requester; and sending repair information at least containing the repair fee to the repair requester terminal.

Because of the above-mentioned configuration, a method for receiving and sending a repair order using customer's unnecessary assets can be realized, in which by loading the program onto a computer for execution, a repair requester acquiring a repair component can select only an owner capable of providing a second-hand component as a component providing candidate among owners of products including a component desired to be repaired and an optimum repair component can be efficiently searched for.

Furthermore, the present invention is characterized by a recording medium storing a computer-executable program for executing functions of the above-mentioned order receiving and sending system using customer's unnecessary assets as processing operations of a computer. More specifically, the present invention relates to a method for receiving and sending a repair order using customer's unnecessary assets in a network environment in which a provider server provided by a provider is connected to a repairer terminal used by a repairer and a repair requester terminal used by a repair requester on a network, the provider server including: receiving repair request information at least containing information for specifying a product to be repaired and a desired repair fee, transmitted from the repair requester terminal; searching a repairer database storing the repairers and products that can be repaired by the repairers so that they correspond to each other, based on the information for specifying a product to be repaired, and extracting one or a plurality of candidate repairers that can repair the product; notifying the repairer terminal used by the candidate repairer of repair request information from the repair requester; selecting the candidate repairer with the lowest repair fee as a repairer, among the entire input repair information; and notifying the repair requester terminal of the repair information and order receiving, and notifying the repairer terminal of order sending, and a program for realizing the operations of the method.

Because of the above-mentioned configuration, a method for receiving and sending a repair order using customer's unnecessary assets can be realized, in which by loading the program onto a computer for execution, a repair requester acquiring a repair component can select an appropriate repairer from a plurality of repairers without searching for a repairer.

Next, in order to achieve the above-mentioned object, a repair order receiving and sending system using customer's unnecessary assets of the present invention is operated on a repairer server provided by a repairer in which the repairer server, a repair requester terminal used by a repair requester, and a component providing candidate terminal used by a component providing candidate are connected to each other on a network, the repairer server including: a component information database storing components and products using the components so that they correspond to each other; and an owner information database storing customers owning the products as potential component providers, wherein repair request information at least containing failure information on a product to be repaired and a desired repair fee is sent from the repair requester terminal to the repairer server, in the repairer server, a repair component is specified based on the failure information, and the component information database and the owner information database are searched based on the specified repair component, whereby one or a plurality of customers owning one or a plurality of products including the repair component is selected as the component providing candidate, a reference purchase price is input based on the desired repair fee, and the component providing candidate terminal used by the selected component providing candidate is notified of purchase component information at least containing information for specifying a product desired to be purchased and the reference purchase price of the product desired to be purchased, selling component information containing a desired selling price of the repair component based on the purchase component information is sent from the component providing candidate terminal to the repairer server, and in the repairer server, a component provider is selected from the component providing candidates based on the selling component information, a repair fee presented to the repair requester is input, and repair information at least containing the repair fee is sent to the repair requester terminal.

Because of the above-mentioned configuration, a repair requester acquiring a repair component can select only an owner capable of providing a second-hand component as a component providing candidate among owners of products including a component desired to be repaired, and optimum repair means can be efficiently searched for.

Next, in order to achieve the above-mentioned object, a repair order receiving and sending system using customer's unnecessary assets of the present invention supports repair of a broken-down apparatus, wherein repair request information at least containing failure information for specifying a product or a component targeted for repair, a desired repair fee, and information on whether or not the use of a second-hand component is accepted is input to go on public on a network, regarding a repair component specified based on the repair request information and a product including the repair component, public buying on the network is supported, one or a plurality of estimated repair fees including information on whether or not the use of a second-hand component is accepted with respect to the repair request information is displayed together with estimators, and an estimated repair fee targeted for requesting repair is selected from the one or plurality of estimated repair fees, and a repair request with respect to the estimator who presents the selected estimated repair fee is input.

Because of the above-mentioned configuration, a repair requester acquiring a repair component can select a component providing candidate through an estimator presenting a most appropriate estimated repair fee, irrespective of whether a component desired to be repaired is a new component or a second-hand component, and an optimum repair component can be efficiently searched for.

These and other advantages of the present invention will become apparent to those skilled in the art upon reading and understanding the following detailed description with reference to the accompanying figures.

### BRIEF DESCRIPTION OF THE DRAWINGS

FIGS. 1A and 1B show a configuration of a conventional repair system.

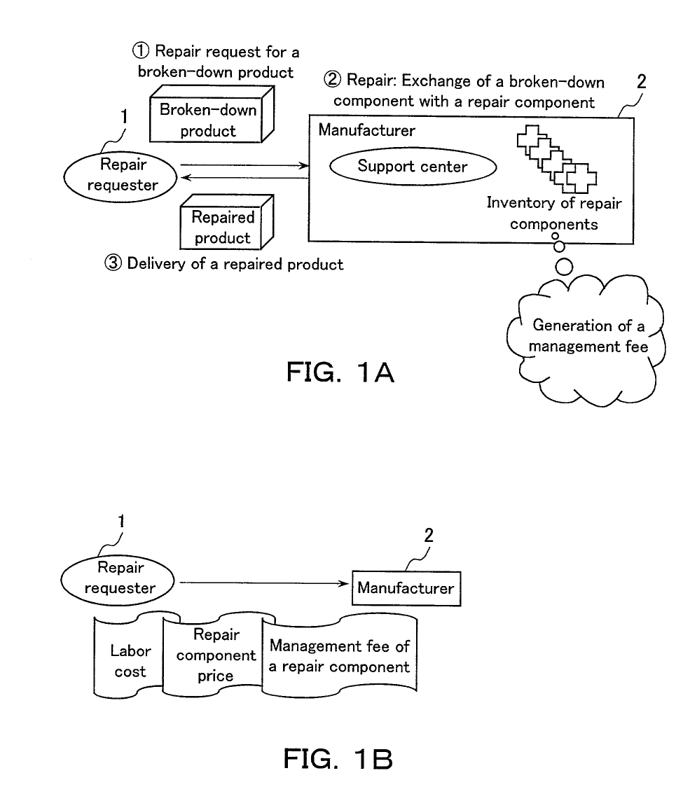

FIGS. 2A and 2B show a configuration of a conventional repair order receiving and sending system using customer's unnecessary assets.

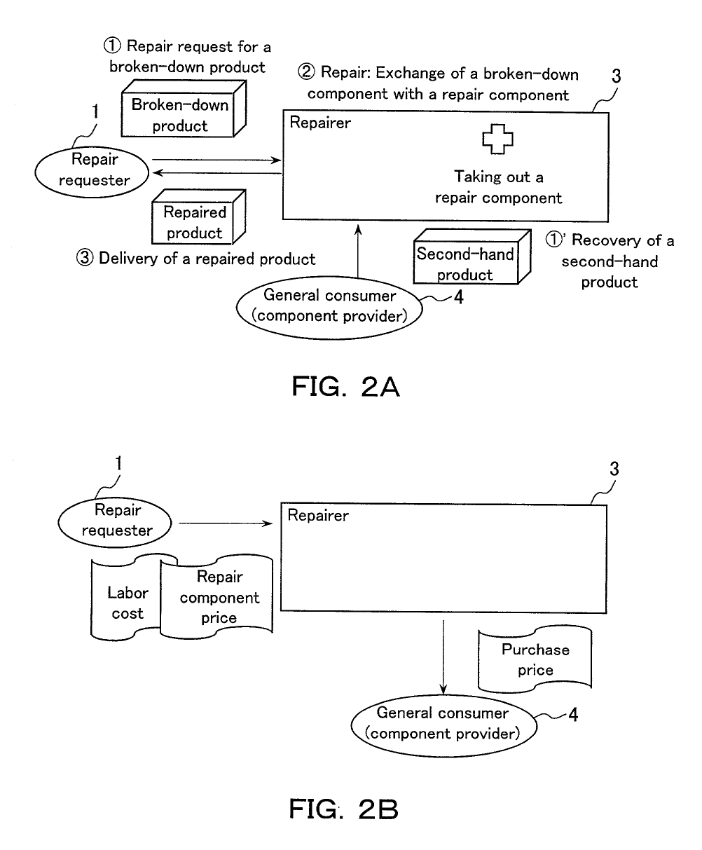

FIG. 3 shows a configuration of a repair order receiving and sending system using customer's unnecessary assets of Embodiment 1 according to the present invention.

FIG. 4 is an image diagram showing a repair request screen in the repair order receiving and sending system using customer's unnecessary assets of Embodiment 1 according to the present invention.

FIG. 5 illustrates a data configuration of a component information database in the repair order receiving and sending system using customer's unnecessary assets of Embodiment 1 according to the present invention.

FIG. 6 illustrates a data configuration of an owner information database in the repair order receiving and sending system using customer's unnecessary assets of Embodiment 1 according to the present invention.

FIG. 7 is a flow chart showing processing in a component price adjusting part in the repair order receiving and sending system using customer's unnecessary assets of Embodiment 1 according to the present invention.

FIG. 8 shows a configuration of the repair order receiving and sending system using customer's unnecessary assets of Embodiment 1 according to the present invention.

FIG. 9 is a flow chart showing processing in a repairer server in the repair order receiving and sending system using customer's unnecessary assets of Embodiment 1 according to the present invention.

FIG. 10 shows a configuration of a repair order receiving and sending system using customer's unnecessary assets of Embodiment 2 according to the present invention.

FIG. 11 illustrates a data configuration of a component information database in the repair order receiving and sending system using customer's unnecessary assets of Embodiment 2 according to the present invention.

FIG. 12 is a flow chart showing processing in a provider server in the repair order receiving and sending system using customer's unnecessary assets of Embodiment 2 according to the present invention.

FIG. 13 illustrates a computer environment.

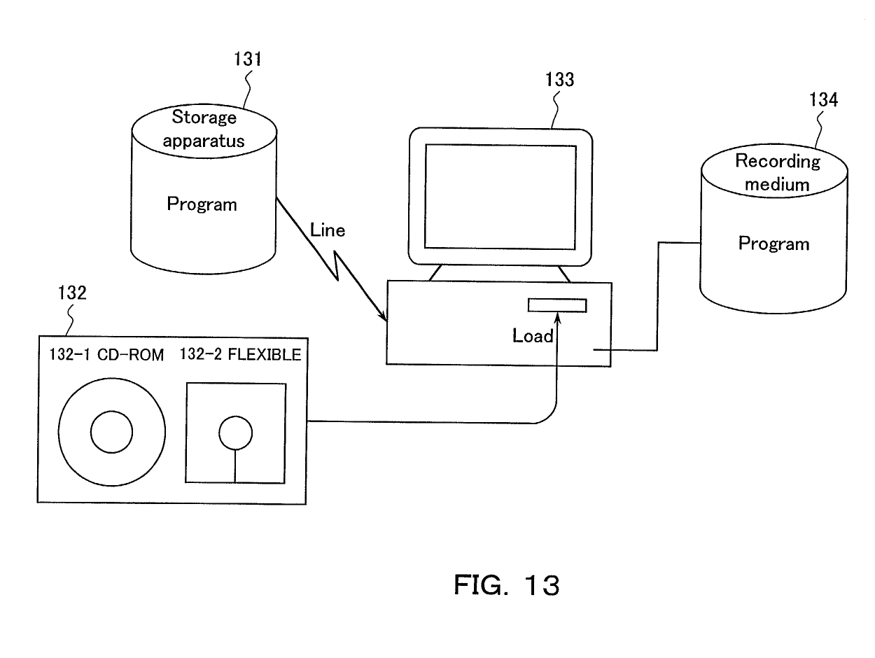

### DESCRIPTION OF THE PREFERRED EMBODIMENTS

Embodiment 1

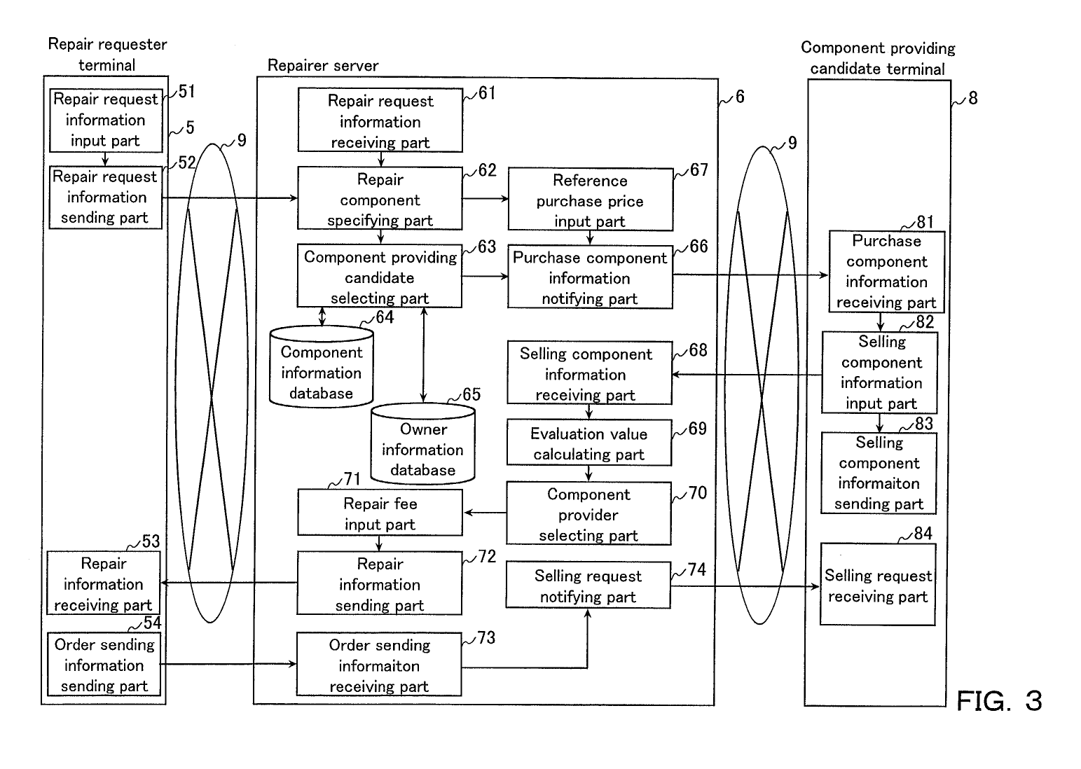

Hereinafter, a repair order receiving and sending system using customer's unnecessary assets of Embodiment 1 according to the present invention will be described with reference to the drawings. FIG. 3 shows a configuration of the repair order receiving and sending system using customer's unnecessary assets of Embodiment 1 according to the present invention. In FIG. 3, reference numeral 5 denotes a repair requester terminal, 6 denotes a repairer server, 8 denotes a component providing candidate terminal, and 9 denotes the Internet, respectively. In the present embodiment, each terminal is connected to the repairer server 6 through the Internet 9. The present invention is not particularly limited thereto. Any communication means capable of sending and receiving information may be used.

The repairer server 6 is generally provided by a repairer. Needless to say, a manufacturer of a product may provide the repairer server 6 so as to make repairs.

First, a repair requester inputs failure information on a product to be repaired and the upper limit value of a desired repair fee from a repair request information input part 51 at the repair requester terminal 5. This means that the repair requester determines it worthwhile to continue to use the product of interest by having it repaired, if a repair fee is equal to or lower than the input desired repair fee. That is, the repair requester believes that it is better to purchase a new product in the case where a repair fee exceeds the desired repair fee. Thus, this procedure has the significance of showing a sense of values peculiar to the repair requester.

Examples of failure information on a product to be repaired include a product name, a type number, a production date, contents and states of failure, etc. The repairer server 6 specifies a target component for repair/exchange, based on the information.

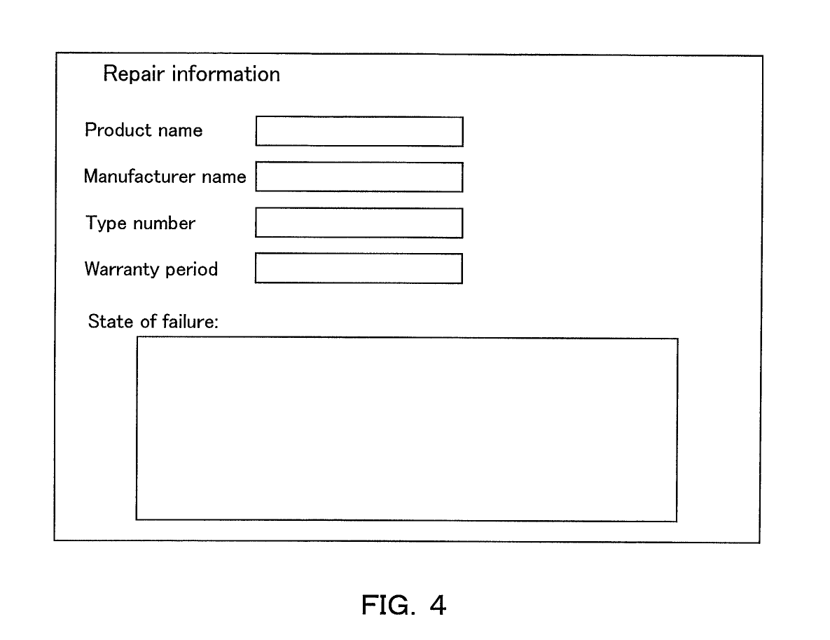

FIG. 4 shows an example of a screen image in the repair request information input part 51. As shown in FIG. 4, in the repair request information input part 51, a product name, a manufacturer name, a type number, a production date, contents and states of failure, and the like are input. The screen image is not particularly limited to that shown in FIG. 4. For example, the screen image may be designed in such a manner that information on the contents and states of failure, etc. is selectively input on the product basis so as to make it easy to find the cause of failure.

Next, the failure information and desired repair fee on the product to be repaired are sent from the repair request information sending part 52 to the repairer server 6 through the Internet 9. In the repairer server 6, a repair request information receiving part 61 receives the information, and a repair component specifying part 62 specifies a component required for repair and the required number of the components, based on the failure information on the product to be repaired.

Then, based on the specified repair component, a component providing candidate selecting part 63 refers to a component information database 64 storing components and products using the components so that they correspond to each other and an owner information database 65 storing customers owning products as potential component providers, thereby selecting one or a plurality of customer(s) owning a product containing a repair component as component providing candidate(s).

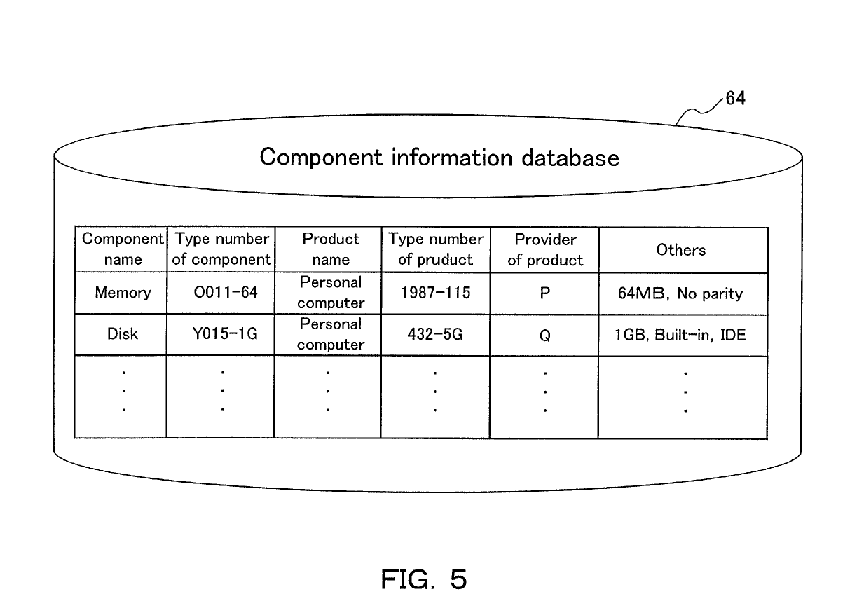

The component information database 64 has a data configuration as shown in FIG. 5. More specifically, the component information database 64 stores a product name, a type number, and a provider name (manufacturer name) on the component basis so that a product containing the component can be specified. The data configuration shown in FIG. 5 is an example. The present invention is not particularly limited thereto.

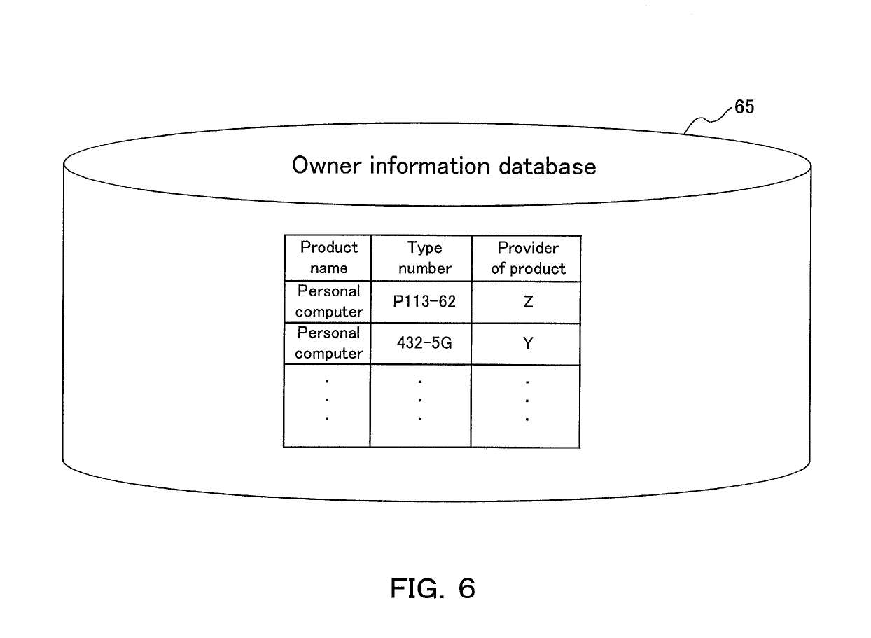

The owner information database 65 has a data configuration as shown in FIG. 6. More specifically, the owner information database 65 stores customers owning the product of interest as potential component providers on the product basis. The data configuration shown in FIG. 6 is an example. The present invention is not particularly limited thereto.

Information (e.g., a component name, a type number, etc.) specifying a component desired to be purchased, and a reference price showing the upper limit value of the price presented by component providing candidates, input at a purchase reference price input part 67, are sent from a purchase component information notifying part 66 to the component providing candidate terminal 8 used by the component providing candidate selected at the component providing candidate selecting part 63. This will be described in more detail. The desired repair fee is input by the repair requester. Therefore, when a purchase price of a component exceeds an amount obtained by subtracting a labor cost and the like incurred in repair/exchange from the desired repair fee, the repair/exchange cannot be made under the desired repair fee. In order to avoid this, a purchase reference price presented by the component providing candidate is notified in advance.

In general, a purchase reference price can be obtained by subtracting a repair labor cost and the like from a desired repair fee (desired repair fee−repair labor cost, etc.). Therefore, instead of that a repairer inputs a purchase reference price at the purchase reference price input part 67, the repairer server 6 may automatically calculate a purchase reference price.

When the component providing candidate receives the above-mentioned purchase reference price and the like at a purchase component information receiving part 81 at the component providing candidate terminal 8, only in the case where the component providing candidate determines that it is possible to provide a component at a price equal to or lower than the purchase reference price, the component providing candidate inputs a desired selling price of the repair component from a selling component information input part 82. The information to be input includes not only a desired selling price, but also other information required for determining a residual value of a repair component, such as a remaining warranty period of a repair component and a product purchase date.

Then, the selling component information including the input desired selling price is sent to the repairer server 6 from a selling component information sending part 83 through the Internet 9. The repairer server 6 receives the selling component information at a selling component information receiving part 68.

Next, an evaluation value calculating part 69 calculates an evaluation value showing a use value to the repair requester in accordance with the information for calculating a residual value of the repair component, such as a desired selling price and a remaining warranty period, based on the selling component information received at the selling component information receiving part 68.

Various methods for calculating an evaluation value can be considered. First, a calculation method based on how many years a second-hand product containing the component has been used. In this case, a standard service life of a target component for repair/exchange when it is new is obtained, and a remaining warranty period at a time when a desired selling price is presented by a component providing candidate is calculated.

More specifically, a period is calculated from the date when a product containing the component purchased by a component providing candidate to the date when a price is represented, and the calculated period is considered as use years. Then, by subtracting the use years from the standard service life, a remaining warranty period can be calculated.

When the remaining warranty period is calculated, the evaluation value of the repair component can be obtained from the following Formula 1.

(Evaluation value)=(Component cost)×(Remaining warranty period)/(Standard service life of a component) (1)

A calculation method based on to which degree a component is consumed is also considered. In this case, a durability curve of a component is obtained, whereby a remaining life thereof is obtained. When the remaining life of the component is calculated, the evaluation value of the repair component can be obtained from the following Formula 2.

(Evaluation value)=(Component cost)×(Remaining life of a component)/(Standard service life of a component) (2)

When the evaluation value of the repair component is calculated, a component providing candidate who provides a repair component with the highest evaluation value is selected as a component provider at a component provider selecting part 70.

A purchase price of the repair component is determined at this time. Therefore, a repair fee considering a labor cost and like is input at a repair fee input part 71, and the repair fee is sent from a repair information sending part 72 to the repair requester terminal 5, together with repair information such as the kind and number of exchange components and repair complete date and time.

The repair requester receives the repair information such as the kind and number of exchange components and repair complete date and time, as well as the repair fee at a repair information receiving part 53. If there is no problem in conditions, the repair requester sends a notice of confirmation of order sending from an order sending information sending part 54 to the repairer server 6.

When the repairer server 6 receives the notice of confirmation of order sending at an order sending information receiving part 73, a purchase price is also determined at this time. Therefore, a selling request notifying part 74 sends confirmation of order sending to the component providing candidate terminal 8 selected as a component provider through the Internet 9. That is, the selling request notifying part 74 notifies the component providing candidate terminal 8 that the component providing candidate terminal 8 is selected as a component provider and sends information regarding a purchase price thereto. The component providing candidate terminal 8 receives the confirmation of order sending at a selling request receiving part 84, and is ready for delivery and payment.

In Embodiment 1, the repairer server 6 selects a component provider based an evaluation value. However, it may also be possible that an evaluation value is sent to the repair requester terminal 5, and the right of final selection is provided to a repair requester.

In Embodiment 1, a repair component targeted for calculating an evaluation value is limited to those provided at a price equal to or lower than a reference purchase price. However, in the case where a repair fee desired by a repair requester is way below a market value, corresponding repair components may not be found. In such a case, it is also considered that a message for urging a repair requester to input a desired repair fee again is sent from the repairer server 6, or negotiation with a component providing candidate is permitted.

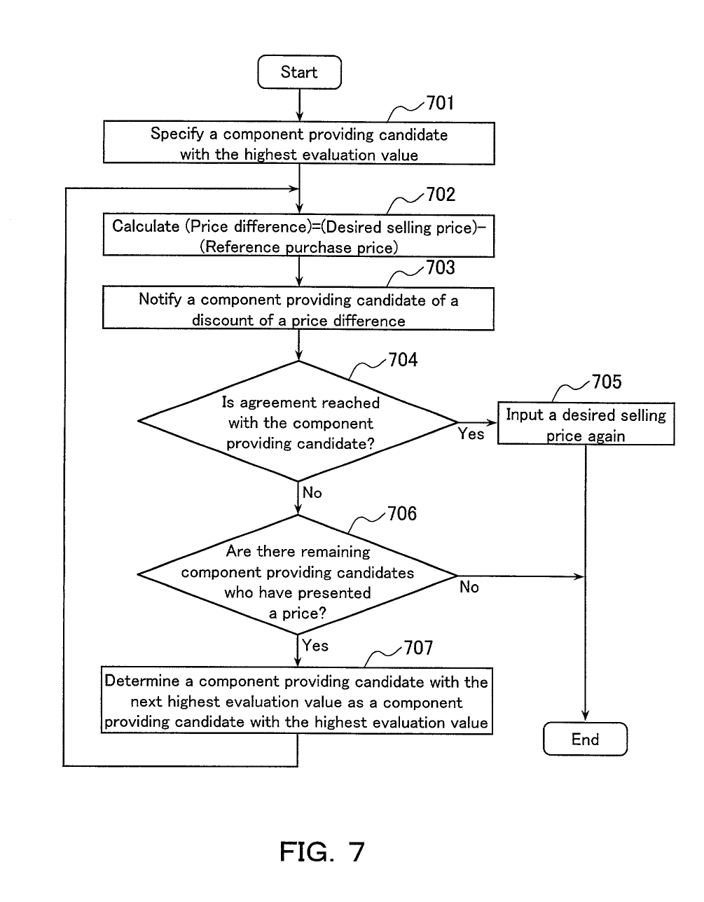

Particularly, in the latter case, evaluation values are calculated for all the component providing candidates that present desired selling prices, and a component price adjusting part 75 for processing as shown in FIG. 7 is provided. FIG. 7 is a flow chart showing processing in the component price adjusting part 75.

In FIG. 7, first, a component providing candidate having the highest evaluation value is specified (Operation 701). Then, in order to clarify the difference between the desired repair fee of a repair requester and the desired selling price, a reference purchase price is subtracted from the desired selling price presented by the component providing candidate to calculate a price difference to be negotiated (Operation 702). In order to sound out the component providing candidate about the possibility of a discount of the price difference, the component providing candidate is notified of a request for discount of the desired selling price by the price difference.

In the case where the component providing candidate agrees to a discount of the desired selling price (Operation 704: Yes), a desired selling price is input again (Operation 705).

In the case where the component providing candidate does not agree to a discount of a desired selling price (Operation 704: No), a component providing candidate with the next highest evaluation value is determined as a component providing candidate (Operation 707). Then, the processing after Operation 702 is repeated until no component providing candidate presenting a selling price is available (Operation 706: No), whereby an agreement point of a selling price of a repair component can be found.

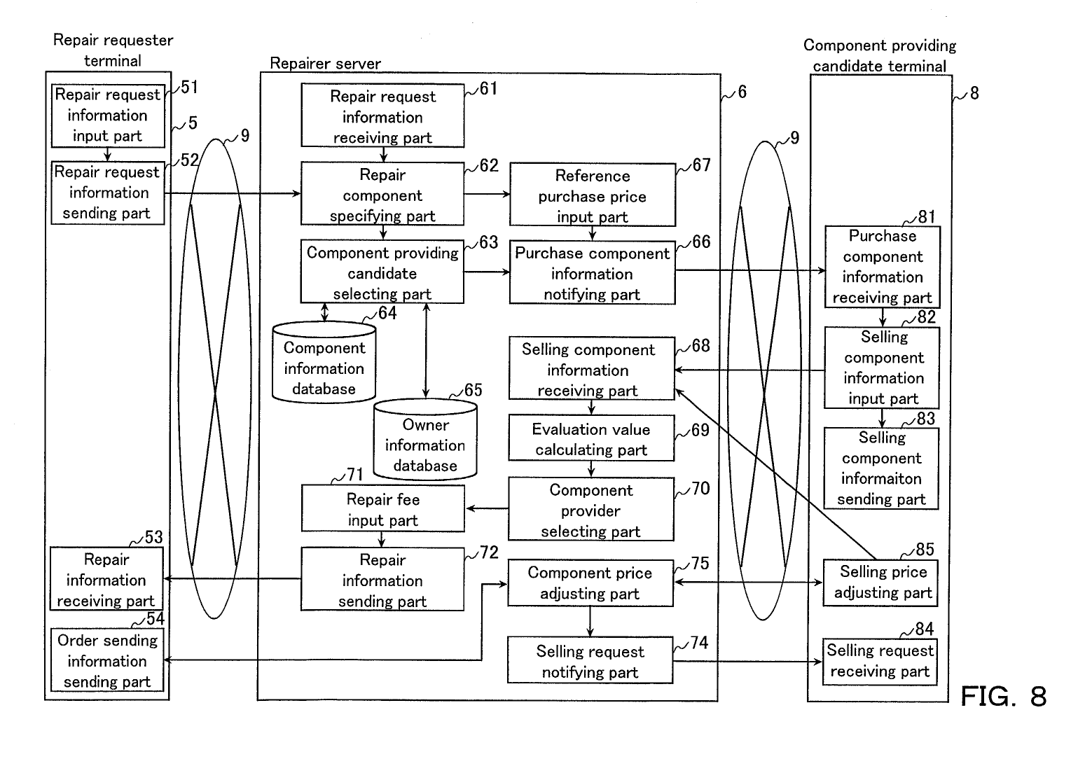

As shown in FIG. 8, the component price adjusting part 75 is positioned in a previous stage of the selling request notifying part 74, and plays a role as a relay point between the repair fee adjusting part 55 at the repair requester terminal 5 and a selling price adjusting part 85 at the component providing candidate terminal 8. When an agreement is reached on a discount of a desired selling price, the component providing candidate inputs a desired selling price at the selling price adjusting part 85, and sends it to the repairer server 6.

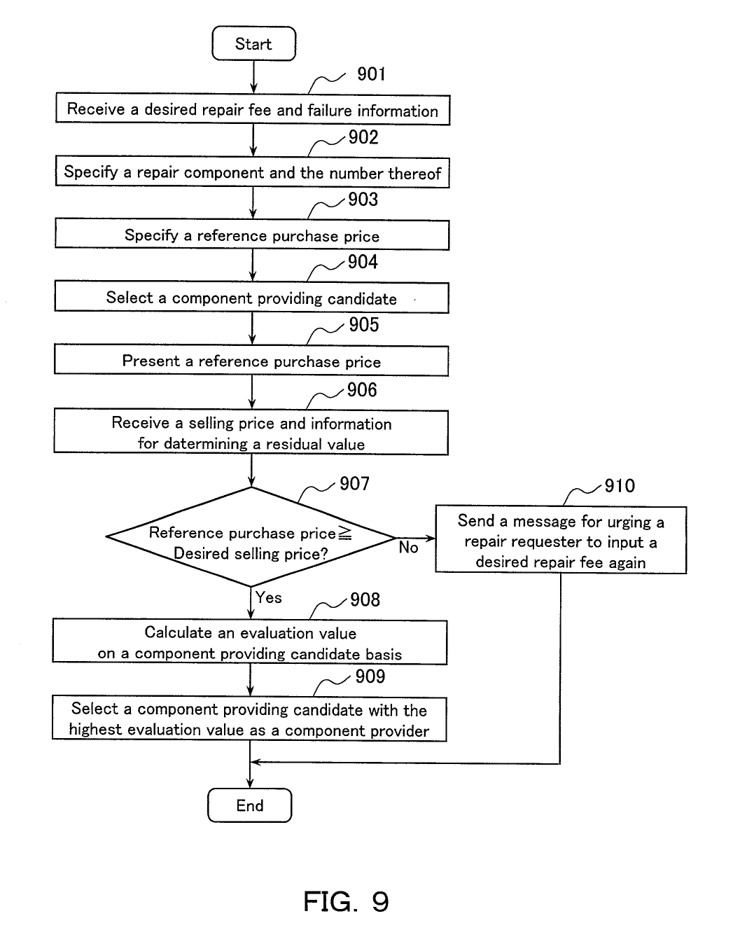

The repairer server 6 having the above-mentioned functions is required to conduct the processing as described below. FIG. 9 is a flow chart showing processing in the repairer server 6 in the repair order receiving and sending system using customer's unnecessary assets of Embodiment 1 according to the present invention.

In FIG. 9, information on a desired repair fee and the state of failure is received (Operation 901). Based on the information on the state of failure, a repair component and the number thereof are specified (Operation 902). A reference purchase price is specified based on the desired repair fee (Operation 903).

On the other hand, component providing candidates are selected by referring to the component information database and the owner information database based on the specified repair component (Operation 904). Then, a repair component and a reference purchase price are presented as purchase component information to the selected component providing candidates (Operation 905).

Next, information for determining a residual value of a repair component, such as a desired selling price and a warranty period, is received from the component providing candidates.

In the case where a reference purchase price is equal to or higher than a purchase price presented by the component providing candidates (Operation 907: Yes), an evaluation value of a repair component is calculated on the basis of a component providing candidate (Operation 908). A component providing candidate with the highest evaluation value is selected as a component provider of the repair component (Operation 909).

On the other hand, in the case where a reference purchase price is lower than the desired purchase price presented by the component providing candidates (Operation 907: No), a repair requester is notified of a message for urging the repair requester to input a desired repair fee again (Operation 910).

As described above, in Embodiment 1, a repair requester acquiring a repair component can select a component provider of a repair component, based on an evaluation value of the repair component that is an index for objectively evaluating a use value. Therefore, compared with the case of directly requesting repair of a manufacturer, effective repair can be made more exactly at a lower cost.

Embodiment 2

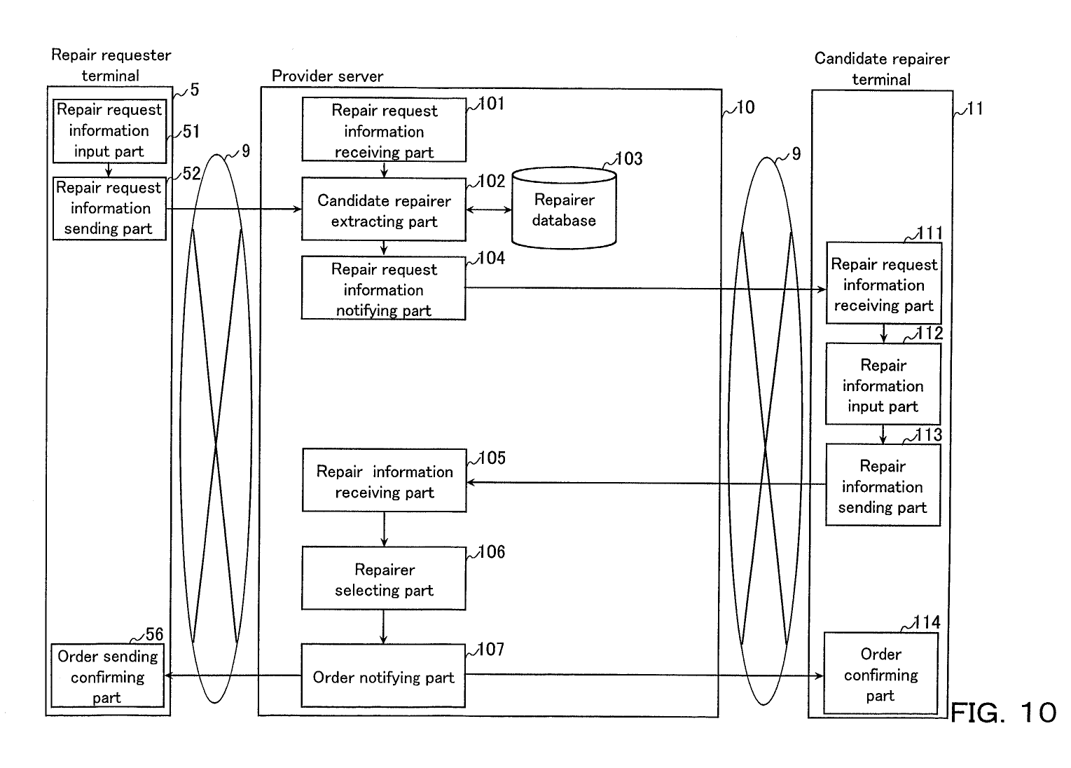

Hereinafter, a repair order receiving and sending system using customer's unnecessary assets of Embodiment 2 according to the present invention will be described with reference to the drawings. FIG. 10 shows a configuration of a repair order receiving and sending system using customer's unnecessary assets of Embodiment 2 according to the present invention. In FIG. 10, reference numeral 5 denotes a repair requester terminal, 10 denotes a provider server, 11 denotes a candidate repairer terminal, and 9 denotes the Internet, respectively.

The configuration shown in FIG. 10 is similar to that of Embodiment 1, except that a provider server 10 is adopted instead of the repairer server 6.

In Embodiment 1, a repair requester individually has to access the repairer server 6. Therefore, in the case where a repair requester makes a repair request of a plurality of repairers, it is required for the repair requester to investigate which repairer is available. In Embodiment 2, a repair requester only needs to access the provider server 10, and the provider server 10 selects a repairer. Therefore, the repair requester only waits for presentation of a repairer and a repair fee thereof from the provider server 10. This substantially alleviates the burden of the repair requester.

In Embodiment 2, each terminal is connected to the provider server 10 through the Internet 9. The present invention is not limited thereto. Any communication means capable of transmitting/receiving information can be used.

In FIG. 10, first, a repair requester inputs failure information on a product to be repaired and the upper limit value of a desired repair fee from the repair request information input part 51 at the repair requester terminal 5.

Examples of failure information on a product to be repaired include a product name, a type number, a production date, contents and states of failure, etc. Based on the information, the provider server 10 specifies a repairer capable of repairing/exchanging the product.

Next, the failure information and desired repair fee on the product to be repaired are sent as repair request information from the repair request information sending part 52 to the provider server 10 through the Internet 9. In the provider server 10, a repair request information receiving part 101 receives the information, and a candidate repairer extracting part 102 refers to a repairer database 103 storing repairers so that they correspond to products which the repairers can repair, thereby extracting one or a plurality of available candidate repairers).

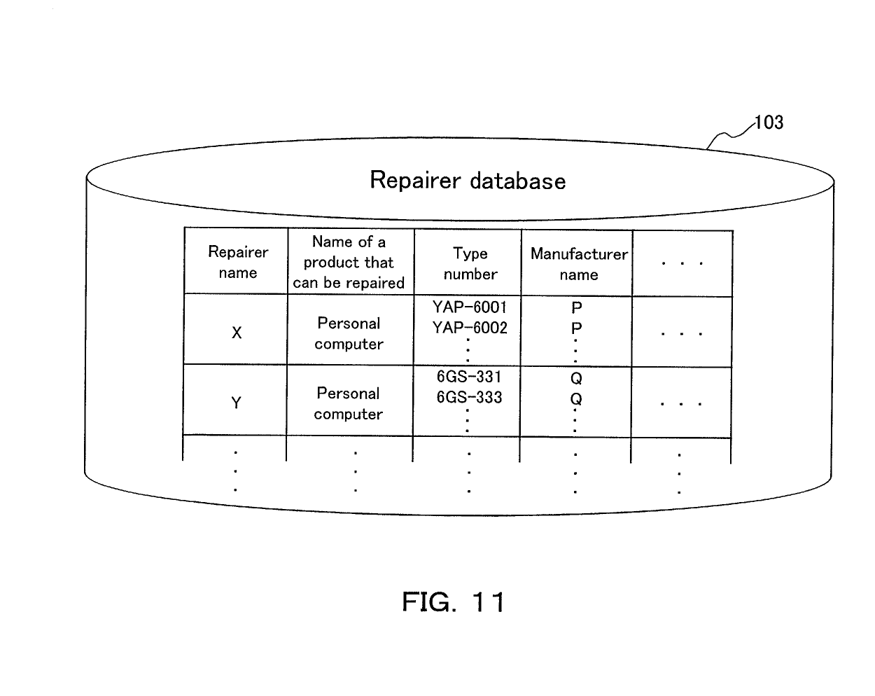

Herein, the repairer database 103 has a data configuration as shown in FIG. 11. More specifically, the repairer database 103 stores a product name, a type number, a manufacturer name, and the like of a product that can be repaired on the repairer basis, so that a repairer capable of repairing a product can be specified. The data configuration shown in FIG. 11 is an example, and the present invention is not limited thereto.

A repair request information notifying part 104 sends the repair request information, which is sent from the repair requester, to the candidate repairer terminal 11 used by the candidate repairer.

The candidate repairer receives the repair request information in a repair request information receiving part 111, and inputs, as repair information, repair contents and a desired order receiving price based on the repair request information in a repair information input part 112, and sends them from a repair information sending part 113 to the provider server 10.

When the repair information receiving part 105 receives the repair information from candidate repairers, a repairer selecting part 106 selects a candidate repairer whose repair fee is lowest as a repairer.

Finally, the order notifying part 107 sends a notice of order receiving confirmation to the selected repairer. At the same time, the order notifying part 107 sends a notice of confirmation of an order destination for a repair request to the repair requester.

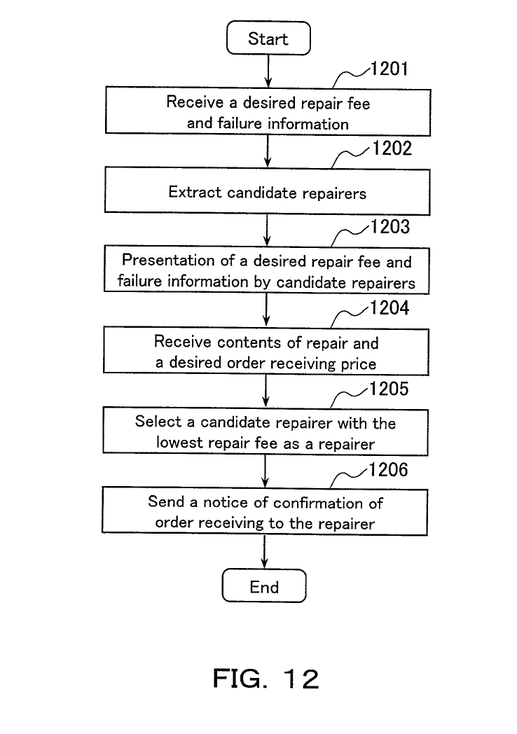

The provider server 10 having the above-mentioned functions is required to conduct the following processing. FIG. 12 is a flow chart showing processing in the provider server 10 in the repair order receiving and sending system using customer's unnecessary assets of Embodiment 2 according to the present invention.

In FIG. 12, first, information on a desired repair fee and the state of failure is received (Operation 1201). By referring to the repairer database 103 storing repairers so that they correspond to products that can be repaired, one or a plurality of available candidate repairers are extracted (Operation 1202).

Then, information on a desired repair fee and the state of failure is presented to the extracted candidate repairers (Operation 1203). Repair information from the candidate repairers (i.e., contents of repair and a desired order receiving price based on the repair request information) are received (Operation 1204).

A candidate repairer whose desired order receiving price is lowest among the received desired order receiving price is selected as a repairer (Operation 1205), and a notice of order receiving confirmation is sent to a selected repairer (Operation 1206).

As described above, in Embodiment 2, a repair requester only needs to access a provider server as a repair request destination, and can select a repairer whose repair fee is lowest. Therefore, compared with the case where a repair requester makes a repair request directly of a manufacturer, repair can be made more exactly at a lower cost.

Embodiment 3

Hereinafter, a repair order receiving and sending system using customer's unnecessary assets of Embodiment 3 according to the present invention will be described with reference to the drawings. The configuration of the repair order receiving and sending system using customer's unnecessary assets of Embodiment 3 can be shown by FIG. 10 in the same way as in Embodiment 2 . Embodiment 3 is different from Embodiment 2 in that the provider server 10 does not select a repairer, and a repairer is selected by public buying in which repair request information is disclosed to a general site. In the following description, the case will be described in which the provider server 10 administers a repair order receiving and sending support site on the Internet.

In Embodiment 3, first, a repair requester inputs repair request information from a repair requester terminal 5. The repair request information needs to at least contain failure information required for specifying a product or a component targeted for repair, a desired repair fee, and information on a repair requester's intention whether or not he/she may use a second-hand component. The input repair request information is made public on the Internet by the repair order receiving and sending support site.

Next, a repairer who has browsed through repair request information disclosed on the Internet calculates an estimated repair fee. Such estimation is conducted while referring to a desired repair fee of a repair requester. In the case where the repair requester does not agree to the use of a second-hand component, an estimated repair fee is calculated in the case of using an unused component (new component).

In the case where a product is repaired with an unused component stored by a manufacturer or an unused component stored by a repairer, when an estimated repair fee including a component price, a repair cost, etc. is equal to or lower than the desired repair fee, an estimated fee in the case of using an unused component is presented.

On the other hand, in the case where an estimated repair fee including a component price, a repair cost, etc. exceeds a desired repair fee, public buying of a component to be required is conducted on the repair order receiving and sending support site, for the purpose of finding a less expensive unused component. If there are candidates whose estimated repair fee including a component price, a repair cost, etc. is equal to or lower than a desired repair fee, among component providing candidates who have bidden for the public buying, an optimum component providing candidate is selected among them, an estimated repair fee with respect to the repair request information is calculated and presented to the repair requester.

The repair requester selects a repairer by referring to the presented estimated repair fee, thereby making a repair request (i.e., sending an order). In the case where the repairer bids for the public buying, the repairer buys the component at a time of order sending.

Furthermore, in the case where a repair requester agrees to the use of a second-hand component, an estimated repair fee in the case of using a second-hand component is calculated. More specifically, in the case where a product is repaired with a second-hand component of a repairer, and an estimated repair fee including a component price, a repair cost, etc. is equal to or lower than a desired repair fee, an estimated repair fee in the case of using a second-hand component of the repairer is calculated.

On the other hand, in the case where an estimated repair fee including a component price, a repair cost, etc. exceeds a desired repair fee, public buying of a second-hand component to be required is conducted on the repair order receiving and sending support site, for the purpose of finding a less expensive unused component. If there are candidates whose estimated repair fee including a component price, a repair cost, etc. is equal to or lower than a desired repair fee, among component providing candidates who have bidden for the public buying, an optimum component providing candidate is selected among them, and an estimated repair fee with respect to the repair request information is calculated and presented to the repair requester.

The repair requester selects a repairer by referring to the presented estimated repair fee, thereby making a repair request (i.e., sending an order). In the case where the repairer bids for the public buying, the repairer buys the component at a time of order sending.

As described above, in Embodiment 3, a repair requester acquiring a repair component can select a component providing candidate through an estimator presenting the most appropriate estimated fee, irrespective of whether a component to be repaired is a new component or a second-hand component. Therefore, most optimum repair means can be efficiently searched for.

A program realizing a repair order receiving and sending system using customer's unnecessary assets of the embodiments according to the present invention may be stored in a storage apparatus 131 provided at the end of a communication line, and a recording medium 134 such as a hard disk and a RAM of a computer 133, as well as a portable recording medium 132 such as a CD-ROM132-1 and a flexible disk 132-2. In execution, the program is loaded, and executed on a main memory.

Furthermore, information and the like on a component provided by a repair order receiving and sending system using customer's unnecessary assets of the embodiments according to the present invention may also be stored in a storage apparatus 131 provided at the end of a communication line, and a recording medium 134 such as a hard disk and a RAM of a computer 133, as well as a portable recording medium 132 such as a CD-ROM132-1 and a flexible disk 132-2. For example, such information is read by the computer 133 in using the repair order receiving and sending system using customer's unnecessary assets of the present invention.

As described above, according to the repair order receiving and sending system using customer's unnecessary assets and method thereof according to the present invention, a user acquiring a repair component can determine a destination for acquiring a repair component, based on an evaluation value of a repair component that is an index for objectively evaluating a use value. Therefore, repair can be made more effectively and exactly at a lower cost, compared with the case of making a repair request of a manufacturer.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A repair order receiving and sending system using customer's unnecessary assets operated on a repairer server, in which the repairer server, a repair requester terminal used by a repair requester, and a component providing candidate terminal used by a component providing candidate are connected to each other on a network, the repairer server comprising:
a component information database storing components and products using the components so that they correspond to each other;
an owner information database storing customers owning the products as potential component providers;
a repair request information receiving part for receiving repair request information at least containing failure information on a product to be repaired and a desired repair fee, transmitted from the repair requester terminal;
a repair component specifying part for specifying a repair component based on the failure information;
a component providing candidate selecting part for searching the component information database and the owner information database based on the specified repair component, thereby selecting one or a plurality of customers owning one or a plurality of products including the repair component as the component providing candidate;
a reference purchase price input part for repairer's inputting a reference purchase price based on the desired repair fee;
a purchase component information notifying part for notifying the selected component providing candidate of purchase component information at least containing information for specifying a component desired to be purchased and the reference purchase price of the component desired to be purchased;
a selling component information receiving part for receiving selling component information containing a desired selling price of the repair component from the component providing candidate;
a component provider selecting part for selecting a component provider from the component providing candidate based on the selling component information;
a repair fee input part for inputting a repair fee presented to the repair requester; and
a repair information sending part for sending repair information at least containing the repair fee to the repair requester terminal.

2. A repair order receiving and sending system using customer's unnecessary assets according to claim 1, wherein the selling component information receiving part receives the selling component information together with information for determining a residual value of the repair component,
the repairer server further comprises an evaluation value calculating part for calculating an evaluation value, which is an index for evaluating a residual value of the repair component on the component providing candidate basis, based on the desired selling price and the information for determining a residual value of the repair component, and
the component provider selecting part selects the component providing candidate that provides the repair component with the highest evaluation value as a component provider.

3. A repair order receiving and sending system using customer's unnecessary assets according to claim 1, wherein the repairer server further includes an order sending information receiving part for receiving a notice of order sending information from the repair requester terminal, and a selling request notifying part for notifying the component provider that the product or the repair component is purchased at the desired selling price, based on the order sending information.

4. A repair order receiving and sending system using customer's unnecessary assets operated on a provider server provided by a provider, in which the provider server is connected to a repairer terminal used by a repairer and a repair requester terminal used by a repair requester on a network, the provider server comprising:
a repairer database storing the repairers and products that can be repaired by the repairers so that they correspond to each other;
a repair request information receiving part for receiving repair request information at least containing information for specifying a product to be repaired and a desired repair fee, transmitted from the repair requester terminal;
a candidate repairer extracting part for searching the repairer database based on the information for specifying the product to be repaired, and extracting one or a plurality of candidate repairers that can repair the product;
a repair request information notifying part for notifying the repairer terminal used by the candidate repairer of repair request information from the repair requester;
a repairer selecting part for selecting the candidate repairer with the lowest repair fee as a repairer, among the entire input repair information; and
an order notifying part for notifying the repair requester terminal of the repair information and order receiving, and an order sending notifying part for notifying the repairer terminal of order sending.

5. A repair order receiving and sending system using customer's unnecessary assets according to claim 4, comprising a repair information notifying part for notifying the repair requester terminal of all the repair information sent from the repairer,
wherein the repairer selecting part selects a repairer selected by the repair requester based on the repair information for sending an order, and sent from the repair requester terminal, and
the order notifying part notifies the repairer terminal used by the selected repairer of the order.

6. A repair order receiving and sending system using customer's unnecessary assets according to claim 5, comprising an order receiving part for receiving confirmation of order receiving from the repairer terminal that receives the order, and an order notifying part for notifying the repair requester that the order receiving is established.

7. A method for receiving and sending a repair order using customer's unnecessary assets in a network environment in which a repairer server, a repair requester terminal used by a repair requester, and a component providing candidate terminal used by a component providing candidate are connected to each other on a network, the repairer server comprising:
receiving repair request information at least containing failure information on a product to be repaired and a desired repair fee, transmitted from the repair requester terminal;
specifying a repair component based on the failure information;
searching the component information database storing components and products using the components so that they correspond to each other and the owner information database storing customers owning the products as potential component providers, based on the specified repair component, thereby selecting one or a plurality of customers owning one or a plurality of products including the repair component as the component providing candidate;
inputting a reference purchase price based on the desired repair fee;
notifying the selected component providing candidate of purchase component information at least containing information for specifying a component desired to be purchased and the reference purchase price of the component desired to be purchased;
receiving selling component information containing a desired selling price of the repair component from the component providing candidate;
selecting a component provider from the component providing candidate based on the selling component information;
inputting a repair fee presented to the repair requester; and
sending repair information at least containing the repair fee to the repair requester terminal.

8. A method for receiving and sending a repair order using customer's unnecessary assets in a network environment in which a provider server provided by a provider is connected to a repairer terminal used by a repairer and a repair requester terminal used by a repair requester on a network, the provider server comprising:
receiving repair request information at least containing information for specifying a product to be repaired and a desired repair fee, transmitted from the repair requester terminal;
searching a repairer database storing the repairers and products that can be repaired by the repairers so that they correspond to each other, based on the information for specifying a product to be repaired, and extracting one or a plurality of candidate repairers that can repair the product;
notifying the repairer terminal used by the candidate repairer of repair request information from the repair requester;
selecting the candidate repairer with the lowest repair fee as a repairer, among the entire input repair information; and
notifying the repair requester terminal of the repair information and order receiving, and notifying the repairer terminal of order sending.

9. A recording medium storing a computer-executable program for realizing a method for receiving and sending a repair order using customer's unnecessary assets in a network environment in which a repairer server, a repair requester terminal used by a repair requester, and a component providing candidate terminal used by a component providing candidate are connected to each other on a network, the repairer server comprising:
receiving repair request information at least containing failure information on a product to be repaired and a desired repair fee, transmitted from the repair requester terminal;
specifying a repair component based on the failure information;
searching the component information database storing components and products using the components so that they correspond to each other and the owner information database storing customers owning the products as potential component providers, based on the specified repair component, thereby selecting one or a plurality of customers owning one or a plurality of products including the repair component as the component providing candidate;
inputting a reference purchase price based on the desired repair fee;
notifying the selected component providing candidate of purchase component information at least containing information for specifying a component desired to be purchased and the reference purchase price of the component desired to be purchased;
receiving selling component information containing a desired selling price of the repair component from the component providing candidate;
selecting a component provider from the component providing candidate based on the selling component information;
inputting a repair fee presented to the repair requester; and
sending repair information at least containing the repair fee to the repair requester terminal.

10. A recording medium storing a computer-executable program for realizing a method for receiving and sending a repair order using customer's unnecessary assets in a network environment in which a provider server provided by a provider is connected to a repairer terminal used by a repairer and a repair requester terminal used by a repair requester on a network, the provider server comprising:
receiving repair request information at least containing information for specifying a product to be repaired and a desired repair fee, transmitted from the repair requester terminal;
searching a repairer database storing the repairers and products that can be repaired by the repairers so that they correspond to each other, based on the information for specifying a product to be repaired, and extracting one or a plurality of candidate repairers that can repair the product;
notifying the repairer terminal used by the candidate repairer of repair request information from the repair requester;
selecting the candidate repairer with the lowest repair fee as a repairer, among the entire input repair information; and
notifying the repair requester terminal of the repair information and order receiving, and notifying the repairer terminal of order sending.

11. A repair order receiving and sending system using customer's unnecessary assets operated on a repairer server provided by a repairer, in which the repairer server, a repair requester terminal used by a repair requester, and a component providing candidate terminal used by a component providing candidate are connected to each other on a network, the repairer server comprising:
a component information database storing components and products using the components so that they correspond to each other; and
an owner information database storing customers owning the products as potential component providers,
wherein repair request information at least containing failure information on a product to be repaired and a desired repair fee is sent from the repair requester terminal to the repairer server,
in the repairer server, a repair component is specified based on the failure information, and the component information database and the owner information database are searched based on the specified repair component, whereby one or a plurality of customers owning one or a plurality of products including the repair component is selected as the component providing candidate, a reference purchase price is input based on the desired repair fee, and the component providing candidate terminal used by the selected component providing candidate is notified of purchase component information at least containing information for specifying a product desired to be purchased and the reference purchase price of the product desired to be purchased,
selling component information containing a desired selling price of the repair component based on the purchase component information is sent from the component providing candidate terminal to the repairer server, and
in the repairer server, a component provider is selected from the component providing candidates based on the selling component information, a repair fee presented to the repair requester is input, and repair information at least containing the repair fee is sent to the repair requester terminal.

12. A repair order receiving and sending system using customer's unnecessary assets supporting repair of a broken-down apparatus,
wherein repair request information at least containing failure information for specifying a product or a component targeted for repair, a desired repair fee, and information on whether or not the use of a second-hand component is accepted is input to go on public on a network,
regarding a repair component specified based on the repair request information and a product including the repair component, public buying on the network is supported,
one or a plurality of estimated repair fees including information on whether or not the use of a second-hand component is accepted with respect to the repair request information is displayed together with estimators, and
an estimated repair fee targeted for requesting repair is selected from the one or plurality of estimated repair fees, and a repair request with respect to the estimator who presents the selected estimated repair fee is input.
